(19) United States
(12) Patent Application Publication
(10) Pub. No.: US 2003/0058556 A1
(43) Pub. Date: Mar. 27, 2003

(54) Tape cut-out apparatus and method

(75) Inventor: Hirokazu Komai, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/247,709

(22) Filed: Sep. 20, 2002

(30) Foreign Application Priority Data
Sep. 21, 2001 (JP) P. 2001-288996

(51) Int. Cl. G11B 5/00

(52) U.S. Cl. 360/1

(57) ABSTRACT

The tape cut-out apparatus, having: a control unit for storing a defect positional information showing a position of a defective portion of magnetic tape and, for outputting a predetermined winding length in accordance with the defect positional information; a winding device for drawing out the magnetic tape by an input predetermined winding length, winding it onto a reel and cutting it, and detecting a winding length to the reel and outputting the winding length to the control unit; and, a correcting unit for correcting the input predetermined winding length according to an accuracy of detecting the winding length of the winding device, and correcting an actually measured winding length when the magnetic tape is wound according to an accuracy of detecting the winding length and for outputting the corrected value of the actually measured winding length to the control unit.

### BACKGROUND OF THE INVENTION

The present invention relates to a tape cut-out apparatus which cuts out a piece of magnetic tape from a original roll of the magnetic tape and winds the normal portion of the cut-out magnetic tape onto a reel as a product.

For example, in the case of magnetic tape which is used for information recording tape, there is a fear that, when magnetic material is applied to a flexible support member, dust can adhere to the magnetic tape and a defect can occur in the magnetic tape due to the uneven application of the magnetic material. Such defective portion is to be checked in the stage of the original roll of the magnetic tape.

Also, in the case of magnetic tape which is used to back up data, recently, a servo signal is previously recorded on the data recording surface side thereof. In this magnetic tape, wrong writing of the servo signal gives rise to a defect and, therefore, the magnetic tape is checked as to whether the written servo signal has a defect or not.

On the other hand, in the case of magnetic tape which is wound on a original roll of the magnetic tape, by taking up a predetermined length of magnetic tape onto a reel of a small-diameter, the magnetic tape is produced as a product. Therefore, conventionally, as an apparatus which draws out a predetermined length of magnetic tape from the original roll of the magnetic tape, cuts it away from the original magnetic tape and winds it onto the small-diameter reel, for example, there is proposed an apparatus which is disclosed in JP-A-7-37362. According to this apparatus, from a original roll of the magnetic tape in which the position of the defective portion of the magnetic tape is previously recognized by a prior check, there is cut out magnetic tape having a predetermined length corresponding to a product to be obtained, while the cut-out magnetic tape is wound onto a reel which is disposed within a cassette.

Also, the present apparatus is structured so as to cut out the magnetic tape based on the defect positional information that is supplied from control unit. That is, when it is judged from the defect positional information that no defective portion is present within the predetermined length of the magnetic tape to be cut out, this predetermined length of magnetic tape is wound on the reel (product reel) disposed within the cassette.

On the other hand, when it is judged that a defective portion is present within the predetermined length of the magnetic tape to be cut out, this predetermined length of magnetic tape is wound on a tape waste disposal reel. By the way, winding of the magnetic tape onto the product reel and winding of the magnetic tape onto the tape waste disposal reel are both executed within the same winding apparatus (winder).

When winding the magnetic tape based on the defective positional information in this manner, in order to wind only the defect-less normal portion of the magnetic tape by a predetermined length, the magnetic tape must be wound by an accurate length, neither too much nor too little.

Therefore, in the winding apparatus, the length of the magnetic tape wound is detected by a length detect roller. The length detect roller has a detect error based on the manufacture error of the length detect roller, while the detect accuracy of the length detect roller varies according to the winding apparatus. For example, in the case of the detect accuracy of +1%, where the winding length is predetermined as 100 m, the actual winding length can be obtained such that 100 m×1.01=101 m. Also, in the case of the detect accuracy of −1%, where the winding length is predetermined as 100 m, the actual winding length can be obtained such that 100 m×0.99=99 m.

Therefore, in the conventional winding apparatus, although the actual winding length is 100 m, in the case of the detect accuracy of +1%, the measured value provides 99 m; and, in the case of the detect accuracy of −1%, the measured value provides 101 m. That is, the measured values cannot be matched to the defect positional information that is recorded in the control unit. In this case, it is impossible to control the winding length accurately, which raises a fear that the defective portion can be wound into the product.

### SUMMARY OF THE INVENTION

The present invention aims at eliminating the drawbacks found in the conventional tape cut-out apparatus. Accordingly, it is an object of the present invention to provide a tape cut-out apparatus which can match an actually measured winding length provided by a winding apparatus to a predetermined winding length predetermined in accordance with defect positional information to thereby be able to control the winding length with accuracy.

In attaining the above object, according to a first aspect of the present invention, there is provided a tape cut-out apparatus, comprising: a control unit for storing a defect positional information showing a position of a defective portion of magnetic tape wound around a original roll of the magnetic tape and, for outputting a predetermined winding length in accordance with the defect positional information; a winding device for drawing out the magnetic tape from the original roll of the magnetic tape by an input predetermined winding length, winding the magnetic tape onto a reel and cutting the magnetic tape, and also for detecting a winding length to the reel and outputting the winding length to the control unit; and, a correcting unit not only for correcting the input predetermined winding length according to an accuracy of detecting the winding length of the winding device, but also for correcting an actually measured winding length of the magnetic tape to be detected when the magnetic tape is wound onto the reel according to an accuracy of detecting the winding length and for outputting the corrected value of the actually measured winding length to the control unit.

According to a second aspect of the present invention, there is provided a tape cut-out apparatus as set forth in the first aspect, wherein the correcting unit corrects the input predetermined winding length due to be multiplied or divided by a correction coefficient.

According to a third aspect of the present invention, there is provided a tape cut-out apparatus as set forth in the second aspect, wherein the correction coefficient is obtained from a measured diameter of a length detect roller.

According to a fourth aspect of the present invention, there is provided a tape cut-out apparatus as set forth in the second aspect, wherein the correction coefficient is obtained from the actually measured winding length of the magnetic tape.

According to a fifth aspect of the present invention, there is provided a tape cut-out method, comprising steps of: storing a defect positional information showing a position of a defective portion of magnetic tape wound around an original roll of the magnetic tape and outputting a predetermined winding length in accordance with the defect positional information; correcting the predetermined winding length according to an accuracy of detecting a winding length; drawing out the magnetic tape from the original roll of the magnetic tape by the corrected predetermined winding length; and, winding the magnetic tape onto a reel, detecting the winding length of the magnetic tape onto the reel and cutting the magnetic tape when the actually measured winding length of the magnetic tape to be detected when the magnetic tape is wound onto the reel corresponds to the corrected predetermined winding length.

According to a sixth aspect of the present invention, there is provided a tape cut-out method as set forth in the fifth aspect, further comprising a step of correcting the actually measured winding length of the magnetic tape according to the accuracy of detecting the winding length.

According to a seventh aspect of the present invention, there is provided a tape cut-out method as set forth in the fifth aspect, wherein the predetermined winding length is corrected due to be multiplied or divided by a correction coefficient.

According to a eighth aspect of the present invention, there is provided a tape cut-out method as set forth in the seventh aspect, wherein the correction coefficient is obtained from a measured diameter of a length detect roller.

According to a ninth aspect of the present invention, there is provided a tape cut-out method as set forth in the seventh aspect, wherein the correction coefficient is obtained from the actually measured winding length of the magnetic tape.

According to the tape cut-out apparatus and method of the present invention, the predetermined winding length to be wound onto the reel based on the defect positional information showing the position of the defective portion of the magnetic tape as well as the actually measured winding length to be detected when the magnetic tape is actually wound are respectively corrected by the correcting unit according to the accuracy of detecting the winding device. Therefore, the predetermined winding length and actually measured winding length can be made to coincide with each other, thereby being able to control the tape length with accuracy.

### BRIEF DESCRIPTION OF THE DRAWINGS

FIG. 1 is a side view of a tape cut-out apparatus according to the present invention;

FIGS. 2A to 2C are views of length control information and defect positional information according to the present invention; and,

FIG. 3 is a flow chart of a cut-out processing to be executed by a tape cut-out apparatus according to the present invention.

### DETAILED DESCRIPTION OF THE PREFERRED EMBODIMENTS

Now, description will be given below in detail of an embodiment of a tape cut-out apparatus according to the present invention with reference to the accompanying drawings.

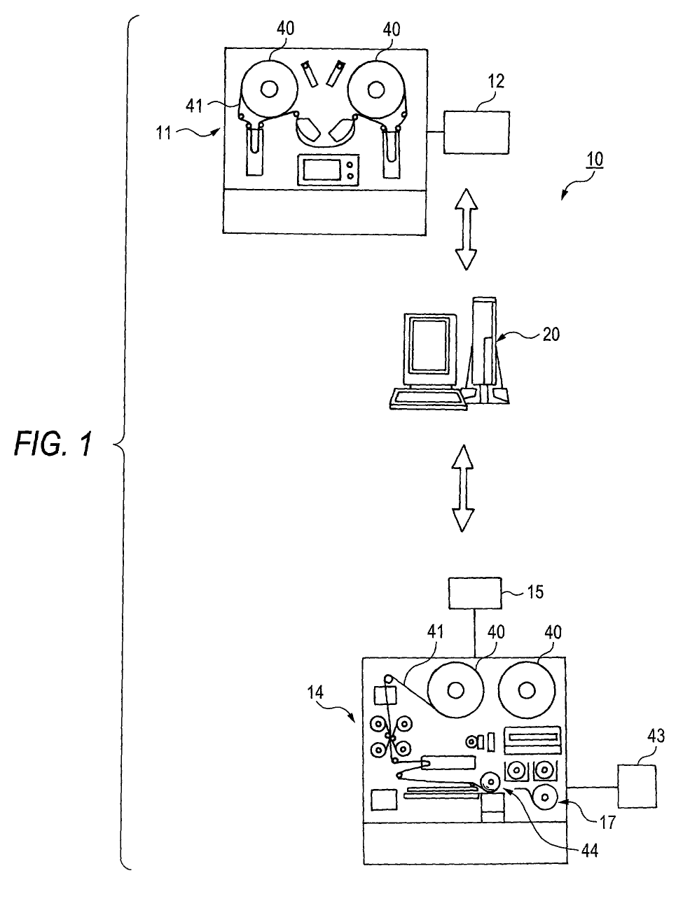

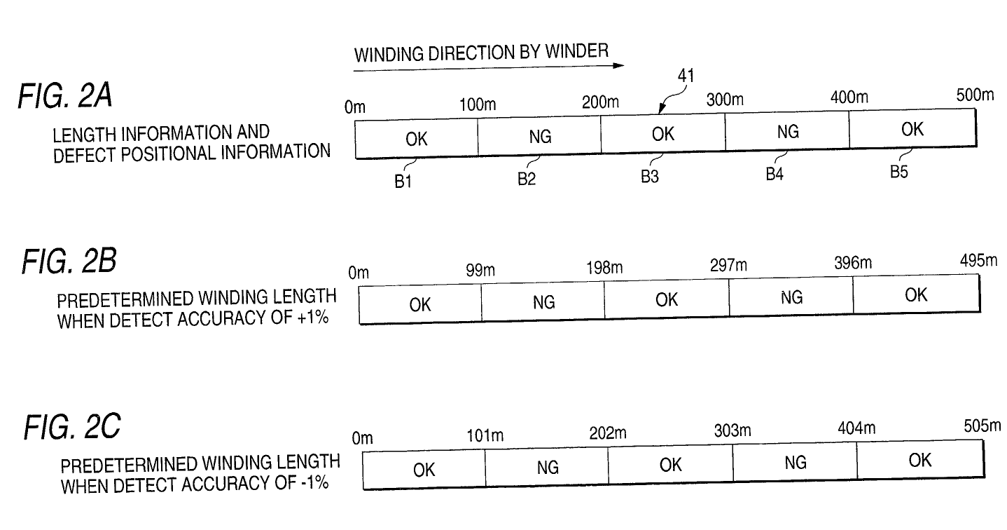

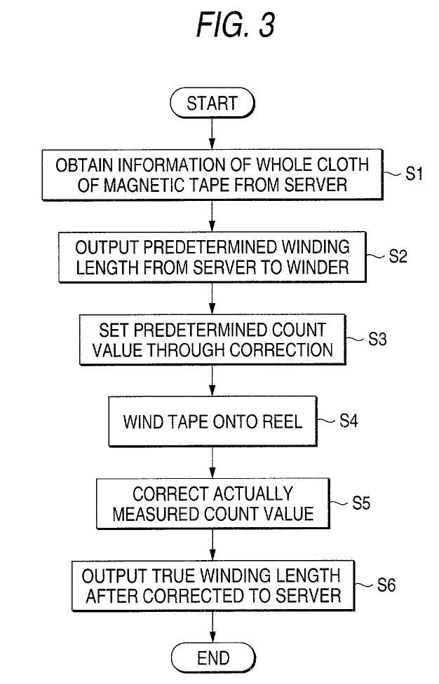

FIG. 1 shows a tape cut-out apparatus according to the present invention, FIGS. 2A to 2C show length control information and defect positional information according to the present invention, and FIG. 3 shows a flow chart of a cut-out processing to be executed by a tape cut-out apparatus according to the present invention.

As shown in FIG. 1, a tape cut-out apparatus 10 according to the present invention comprises a server 20 serving also as control unit of the whole cut-out apparatus 10 which previously stores therein defect positional information showing the position of the defective portion of magnetic tape 41 wound around a original roll of the magnetic tape (pancake member), and a winder (winding apparatus) 14 which, in accordance with the defect positional information stored in the server 20, winds magnetic tape 41 drawn out from the original roll of the magnetic tape 40 onto a reel 44 by a predetermined length.

And, in accordance with the defect positional information showing the position of the defective portion of the magnetic tape 41 wound around the original roll of the magnetic tape 40, a predetermined winding length is input from the server 20 to the winder 14. The magnetic tape 41 having the thus input predetermined winding length is drawn out from the original roll of the magnetic tape 40, is wound onto a reel 44 and is then cut. At the same time, the detect result of the winding length onto the reel 41 is output to the server 20.

Also, the tape cut-out apparatus 10 includes correcting unit 43 for correcting information on the winding length of the magnetic tape 41. This correcting unit 43, as will be discussed later, sets a correction coefficient according to the detect accuracy of the winder 14 and, based on the thus-set correction coefficient, corrects a winding length (predetermined winding length) predetermined to the winder 14 by the server 20 as well as a winding length (actually measured winding length) obtained by actually measuring the magnetic tape 41 wound by the winder 14.

To the server 20, through LAN cables, there are connected a servo writer (servo signal writing device) 11 having a detect function for detecting the defective portion of the magnetic tape 41 wound on the original roll of the magnetic tape 40, the above-mentioned winder 14, and a discharge station 17, in such a manner that they are allowed to communicate with one another. As the server 20, for example, there can be employed a PC server which is composed of a personal computer. By the way, the network connecting system is not limited to the above-mentioned LAN cable system but a wireless system can also be employed.

The servo writer 11, as described above, functions also as a defect check device. That is, the servo writer 11, which is controlled by an terminal 12, has a function to write a servo signal into the magnetic tape 41 wound on the original roll of the magnetic tape 40 and also reads the written servo signal to check whether the servo signal is written properly.

And, the servo writer 11 transmits, through the terminal 12, positional information (defect positional information) on a defective portion, in which a servo signal is not written properly, to the server 20, so that such positional information is recorded in the server 20.

Also, from the servo writer 11 and terminal 12 to the server 20, there are supplied length information as to the respective original rolls of the magnetic tape 40. As this length information, for example, there can be employed such information as shown in FIG. 2A: that is, the magnetic tape 41 of the original roll of the magnetic tape 40 is divided finely in the longitudinal direction thereof into a block 1 (B1), a block 2 (B2), a block 3 (B3), - - - , and a block N (BN); and, the numbers of these blocks B1-BN respectively show the lengths of the magnetic tapes 41 from the starting ends or terminating ends thereof.

By the way, FIG. 2B shows the predetermined lengths in a case where the detect accuracy of the detect unit 42 is +1%, while FIG. 2C shows the predetermined lengths in a case where the detect accuracy of the detect unit 42 is −1%. That is, in the case of the detect accuracy of +1%, for an original winding length, there is predetermined a length which is smaller by 1%; and, in the case of the detect accuracy of −1%, for an original winding length, there is predetermined a length which is larger by 1%.

The above-mentioned defect positional information can be identified by writing OK (normal) or NG (defective) into each of the block numbers. For example, they can be written in the following manner: B1: OK, B2: NG, B3: OK, B4: NG, B5: OK, - - - .

Next, description will be given below of a tape cut-out processing to be executed by the present tape cut-out apparatus 10. Here, as shown in FIG. 2A, as the defect positional information of the magnetic tape 41, there are written OK and NG alternately every 100 m; and, the magnetic tape 41 is wound on the reel 41 by 100 m every time.

In this case, as shown in FIG. 3, firstly, in a state where the original roll of the magnetic tape 40 transferred from the servo writer 11 is loaded into the winder 14 (FIG. 1), the terminal 15 refers to the identification number of the original roll of the magnetic tape 40 and obtains the length information and defect positional information of the original roll of the magnetic tape 40 (FIG. 2A) (Step 1, which will be hereinafter called S1 for short).

Next, the server 20 outputs the predetermined winding length to be wound onto the reel 44 to the winder 44 through the terminal 15 (S2). This predetermined winding length can be predetermined, for example, in the manner of “winding length 100 m”.

Next, the predetermined winding length is corrected by the winder 44 in accordance with a correction coefficient which is set according to the detect accuracy of the winder 14, and the predetermined count value after corrected is set (S3).

That is, in case where the detect accuracy of the winder 14 is +1%, the correction coefficient is 0.99. Therefore, the predetermined count value can be obtained such that 100 m×0.99 (correction coefficient)=99 m.

Next, the winder 14 is controlled according to the predetermined count value and the magnetic tape 41 is wound around the reel 44. And, when the actually measured count value (the value which, the winder 14 itself judges, is actually measured) reaches 99 m, the winding of the magnetic tape 41 ends (S4).

Then, the actually measured count value at the end of the winding by the winder 14 is corrected by the correcting unit 43 (S5). Here, because the correction coefficient is 0.99, the actually measured count value is corrected such that 99 m (actually measured count value)÷0.99 (correction coefficient)=100 m (true winding length) and the thus corrected value (100 m) is transmitted to the server 20.

By the way, in case where the actually measured count value of the winder 14 does not reach the predetermined count value, 100 m, for some reason; for example, in case where the actually measured count value ends in 50 m, the corrected value, that is, 50 m÷0.99=50.5 m is transmitted to the server 20 as the true winding length.

Also, in case where the detect accuracy of the winder 14 is −1%, the correction coefficient is 1.01 and thus the predetermined count value of the winder 14 provides such that 100 m×1.01 (correction coefficient)=10 m. Thus, when the actually measured count value reaches 101 m, the winding of the magnetic tape 41 ends. The actually measured count value, 101 m, is corrected by the correcting unit 43 such that 101 m÷1.01=100 m (true winding length), and the true winding length, 100 m, is transmitted to the server 20.

By the way, to obtain the correction coefficient, for example, the diameter of a length detect roller may be measured with high accuracy, that is, the correction coefficient may be obtained from the measured diameter of the length detect roller. Also, instead of measuring the diameter of the length detect roller, the length wound actually by the winder 14 may be measured and the thus measured length may be compared with the predetermined length to thereby obtain the correction coefficient.

The actually measured count value corrected in Step S5 is output to the server 20 (Step S6). This completes the tape cut-out processing with respect to one reel.

As described above, according to the tape cut-out apparatus 10 of the present invention, when the winder 14 winds a predetermined length of magnetic tape 41 in accordance with the defect positional information stored in the server 20, the predetermined winding length to be predetermined to the winder 14 from the server 20 and the actually measured winding length after end of winding are respectively corrected according to the correction coefficient set in accordance with the previously obtained detect accuracy of the winder 14 in the correcting unit 43, and the actually measured winding length after corrected is transmitted to the server 20.

This can eliminate data difference which is caused by the detect accuracy of the winder 14, so that the length information can be controlled with accuracy. Also, due to such accurate length control, not only there can be eliminated a possibility that a defective portion can be wound into a product, but also the margin can be minimized, thereby being able to enhance the yield rate of the magnetic tape 41.

Also, provision of the correcting unit 43 can reduce the manufacturing accuracy of the length detect roller of the winder 14 to a slight degree, which makes it possible to reduce the cost of the winder 14 itself.

Further, in case where the length detect accuracy of the winder 14 is confirmed periodically and it is found different from the previous detect accuracy, the correction coefficient of the correcting unit 43 may only be changed; that is, the length detect roller of the winder 14 can be used for a long period of time with no need for replacement thereof. That is, due to the extended period for replacement of parts, the costs of the parts can be reduced.

Also, in the case of a plurality of winders 14, the length control values (counter values) of these winders 14 can be controlled collectively. Therefore, the winding length actually measured values of the magnetic tapes 41 of the respective winders 14 coincide with the winding control values recorded in the server 20, which makes is possible to realize accurate length control.

By the way, in the above-mentioned embodiment, for convenience of explanation, the cut-out processing of the magnetic tape 41 is shown in a time series system. However, the servo writer 11, winder 14 and correcting unit 43 operate in parallel and, therefore, they are controlled in accordance with instructions given by the server 20 such that they operate most efficiently.

As has been described heretofore, according to the tape cut-out apparatus of the present invention, the predetermined winding length to be predetermined to the winding device is corrected according to the detect accuracy of the winding device and the actually measured winding length after wound is corrected in accordance with the present predetermined winding length, so that the actually measured winding length and predetermined winding length are allowed to coincide with each other, thereby being able to realize accurate length control.

This not only can prevent the defective portion from being wound into the product but also can minimize the margin, thereby being able to enhance the yield rate of the product. Further, even in case where the detect accuracy of the winding device varies, simply by changing the correction coefficient of the correcting unit, the length detect roller can be used for a long period of time without replacement, which can extend the replacement periods of the parts and thus can reduce the costs of the parts.

What is claimed is:

1. A tape cut-out apparatus, comprising:
a control unit for storing a defect positional information showing a position of a defective portion of magnetic tape wound around a original roll of the magnetic tape and, for outputting a predetermined winding length in accordance with the defect positional information;
a winding device for drawing out the magnetic tape from the original roll of the magnetic tape by an input predetermined winding length, winding the magnetic tape onto a reel and cutting the magnetic tape, and also for detecting a winding length to the reel and outputting the winding length to the control unit; and,
a correcting unit not only for correcting the input predetermined winding length according to an accuracy of detecting the winding length of the winding device, but also for correcting an actually measured winding length of the magnetic tape to be detected when the magnetic tape is wound onto the reel according to an accuracy of detecting the winding length and for outputting the corrected value of the actually measured winding length to the control unit.

2. The tape cut-out apparatus as set forth in claim 1, wherein the correcting unit corrects the input predetermined winding length due to be multiplied or divided by a correction coefficient.

3. The tape cut-out apparatus as set forth in claim 2, wherein the correction coefficient is obtained from a measured diameter of a length detect roller.

4. The tape cut-out apparatus as set forth in claim 2, wherein the correction coefficient is obtained from the actually measured winding length of the magnetic tape.

5. A tape cut-out method, comprising steps of:
storing a defect positional information showing a position of a defective portion of magnetic tape wound around an original roll of the magnetic tape and outputting a predetermined winding length in accordance with the defect positional information;
correcting the predetermined winding length according to an accuracy of detecting a winding length;
drawing out the magnetic tape from the original roll of the magnetic tape by the corrected predetermined winding length; and,
winding the magnetic tape onto a reel, detecting the winding length of the magnetic tape onto the reel and cutting the magnetic tape when the actually measured winding length of the magnetic tape to be detected when the magnetic tape is wound onto the reel corresponds to the corrected predetermined winding length.

6. The tape cut-out method as set forth in claim 5, further comprising a step of correcting the actually measured winding length of the magnetic tape according to the accuracy of detecting the winding length.

7. The tape cut-out method as set forth in claim 5, wherein the predetermined winding length is corrected due to be multiplied or divided by a correction coefficient.

8. The tape cut-out method as set forth in claim 7, wherein the correction coefficient is obtained from a measured diameter of a length detect roller.

9. The tape cut-out method as set forth in claim 7, wherein the correction coefficient is obtained from the actually measured winding length of the magnetic tape.
